(19) United States
(12) Patent Application Publication
(10) Pub. No.: US 2013/0047450 A1
(43) Pub. Date: Feb. 28, 2013

(54) Optical Vertical Plumb Measuring Device

(71) Applicant: John Pelletier, Palm Desert, CA (US)

(72) Inventor: John Pelletier, Palm Desert, CA (US)

(21) Appl. No.: 13/528,661

(22) Filed: Jun. 20, 2012

(51) Int. Cl. G01C 5/00

(52) U.S. Cl. 33/290

(57) ABSTRACT

A tool for projecting a light beam along a vertical surface for the purpose of determining any deviation of that surface from the true vertical, but wherein the light beam is spaced horizontally away from the vertical surface to avoid interference from projections formed in the vertical surface. The tool comprises a light projecting component and a separate, hand held target component upon which projected light impinges. The light projecting component may comprise a linear measurement scale enabling the user to determine the displacement distance of the light projector from the vertical surface. The target component comprises a corresponding linear measurement scale. When light is emitted vertically and strikes the target, measurement readings from both measurement scales are read to determine any discrepancy of the top of the vertical surface from vertical registry with a lower point along the vertical surface at which the light projector is located.

### FIELD OF THE INVENTION

The present invention relates to measurement devices, and more particularly to a device which projects an optical beam to determine when a vertical object is plumb with respect to the ground.

### BACKGROUND OF THE INVENTION

Carpenters and builders have long used bubble levels to determine true horizontal and vertical orientation of structural elements such as components of building walls, partitions, and other building elements. Although the principle of the bubble or spirit level is quite simple, effective application of such a level may not be equally simple. First, there is the issue of determining when the bubble is truly centered within its transparent window. Secondly, a hand held level is dependent upon being seated on a planar surface. Localized imperfections such as bowing of lumber may interfere with accurate determination of true horizontal and vertical orientation of building elements.

Laser based devices have also been utilized in building construction. A typical laser level box is useful for making determination of horizontal planes, but not equally effective in determining vertical orientations. For example, bowed lumber and various projections may interfere with a direct line of sight projection proximate a vertical wall or partition. Should a laser device be moved horizontally away from the wall or partition being scrutinized for vertical orientation to clear an obstruction due to bowing of lumber or presence of a projection, accuracy may be lost in compensating for the horizontal displacement. There exists a need in the art for an accurate device suited for determining vertical orientations.

### SUMMARY OF THE INVENTION

The present invention sets forth an optical device adapted to project a beam of light vertically, and to provide two measurement scales which collectively compensate for horizontal displacement of the projected beam from a vertical building element. The device may be formed in two principal components. One is a beam projector which may be slidably disposed on a base bearing one measurement scale. The beam projector is adjustable then as to proximity to the vertical building element, and may be positioned so that the vertical beam clears the obstruction. The second principal component may comprise a linear arm bearing the second measurement scale, and an adjustable handle which enables the second measurement scale to be hand held at a convenient location relative to the building element and with respect to ergonomic considerations, while still being able to gauge displacement of the projected light beam from the building element.

With the beam projector displaced from abutment with the wall or other building element, an optical beam is projected vertically. The amount of displacement is registered on the first scale. With the second component held by hand so as to project horizontally from the top of the wall or other building element being measured, the point at which the projected light beam intercepts the second scale may be noted. Any discrepancy between the measurement taken at the first scale and the measurement taken at the second scale represents the amount by which the uppermost measured point is out of plumb relative to the lowermost measured point.

It is an object of the invention to be able to project and read displacement of an optical beam along a vertical object while clearing any obstruction which might interfere with direct line of sight.

Another object of the invention is to make such a reading practical and expediently performed by hand.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental side view of an optical measurement tool according to at least one aspect of the invention.

FIG. 2 is a top plan view of a component of the invention seen at the bottom of FIG. 1.

FIG. 3 is a bottom plan view of a component of the invention seen at the top of FIG. 1.

FIG. 4 is an end view of the component of FIG. 2.

### DETAILED DESCRIPTION

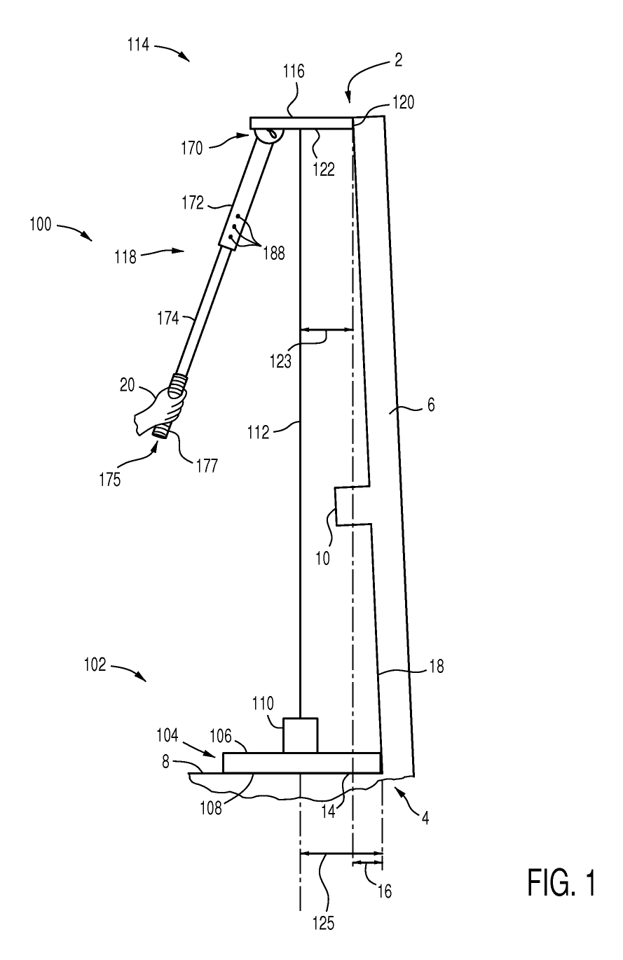

Referring first to FIG. 1, according to at least one aspect of the invention, there is shown an optical measurement tool 100 for determining vertical registry of an upper point 2 located along a vertically extending object with a lower point 4 located along the vertically extending object. In the present example, the vertically extending object may be a framed wall 6 built on a floor surface 8. The framed wall 6 is shown inclining with respect to the floor surface 8. Also, a horizontal board 10 is shown projecting laterally from the framed wall 6.

It should be noted at this point that orientational terms such as left, right, upper, and lower, possibly among others, refer to the subject drawing as viewed by an observer. The drawing figures depict their subject matter in orientations of normal use, which could obviously change with changes in position. Therefore, orientational terms must be understood to provide semantic basis for purposes of description, and do not limit the invention or its component parts in any particular way.

In a typical construction project, it is desirable to establish whether the framed wall 6 is disposed in purely vertical orientation. It will be seen that the horizontal board 10 interferes with a direct line of sight (not called out, but which would extend along the left side of the framed wall 6 if the framed wall 6 were straight) which may be established from the upper point 2 to a point 14 which is located directly and purely vertically below the point 14. In the present example, the point 2 is so displaced to the left by inclination of the framed wall 6 that there is a dimension 16 which horizontally separates the lower point 4 from the point 14, the latter being located where the projection line 18 intersects the floor surface 8. In this situation, a conventional laser type device is ineffective due to the broken line of sight.

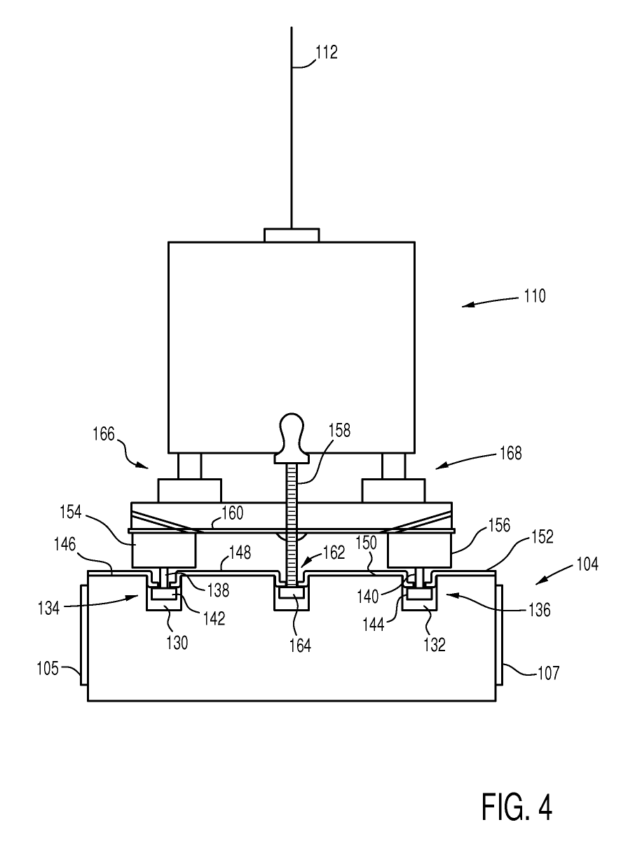

The optical measurement tool 100 overcomes the above described problem as will be detailed after setting forth a possible construction of the optical measurement tool 100. The optical measurement tool 100 may comprise two separate components. The first of these two components may be an optical beam projector component 102 comprising a base 104 having an upper surface 106 and a lower surface 108. The base 104 may have resilient pads 105, 107 located in opposition to one another on the base 104(see FIG. 4) to facilitate grasp by the user.

An optical beam projector 110 is movable along the base 104 and is disposed to project an optical beam 112 vertically when the lower surface 108 is horizontally oriented as seen in FIG. 1. The optical beam projector component 102 may be placed on the floor surface in abutment with the framed wall 6.

The second component is a target component 114 which may comprise a scale member 116 and a handle 118 pivotally coupled to the scale member 116. The scale member 116 may have an end surface 120 and a lower surface 122.

In use, the base 106 of the optical beam projector component 102 is placed in abutment with the framed wall 6 as seen in FIG. 1 and may be left in this position without grasping by hand if engagement with the floor surface 8 is sufficiently stable. The optical beam projector 110 is moved to the left, away from the framed wall 6. The optical beam is then switched on. Beam projectors such as laser beam projectors are well known, being in widespread use in level indicating devices, and need not be described in detail herein other than to observe that they include a lamp or light source, a lens or other agent to collimate and project generated light, a power source such as battery cells, and a switch (these components are not individually shown). The optical beam 112, which is preferably collimated light, and still more preferably a laser beam, is then projected upwardly as shown. Optical characteristics of the optical beam 112 may vary from the nature described herein, but preferably will result in a concentrated area of impingement on the scale member 114 so as to be readily readable by an observer under most if not all ordinarily encountered conditions of use. Also, the area of the beam upon impinging on the scale member 114 will be limited so as not to present problems in determining the correct measurement taken at the scale member 114, hence the use of collimated light and preferably, laser light.

The user (represented by the hand 20) grasps the target component 114 by the handle 118 and holds the scale member 116 in operable position, namely, oriented horizontally and abutting the framed wall 6.

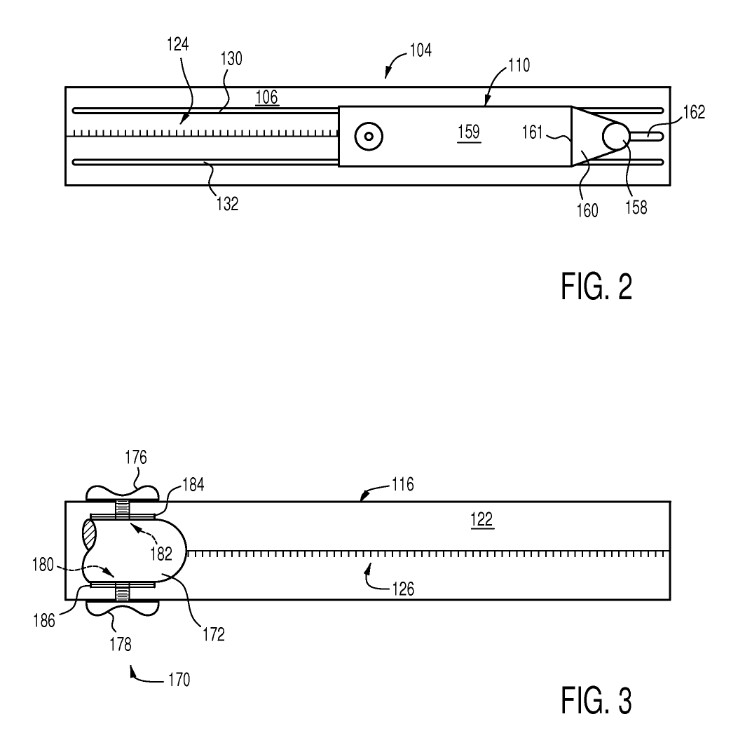

Referring also to FIGS. 2 and 3, the upper surface 106 of the base 104 bears a linear measurement scale 124. The lower surface 122 of the scale member 116 of the target component 114 bears a corresponding or similar linear measurement scale 126. The linear measurement scales 124, 126 may be of the type typically displayed on rulers, tape measures, and the like, wherein a series of graduations is displayed, with some of the graduations having accompanying indicia numerical measurement values, such as those corresponding to centimeters, inches, and the like, and fractions thereof. Obviously, the scales 124, 126, which are shown in symbolic or representative capacity, may include such indicia (not shown).

The user notes the position of the optical beam projector 110 on the base 104 by reading the scale 124. This reading indicates the distance 123 from the window 128 from which the optical beam 112 is emitted to the framed wall 6. The user notes the point at which the optical beam 112 strikes the scale 126 of the scale member 116 when the scale member 116 is held against the framed wall 6 as shown. Any difference between the measurement value of the distance 125 taken from the scale 124 of the base 104 and the measurement value taken from the scale 126 of the scale member 116 represents a deviation from true vertical orientation of the framed wall 6. If the measured value taken from the scale 124 is greater than that taken from the scale 126, then it may be concluded not only that the framed wall 6 is out of true vertical orientation, but also that the framed wall 6 is inclined in the direction shown in FIG. 1. In the example illustrated in FIG. 1, 125 is greater than 123, thereby indicating inclination or other displacement of the framed wall 6 from a true vertical orientation. Magnitude of this deviation is indicated by the distance 16.

Of course, reversal in magnitude of the two measured values 125 from the example presented above would indicate inclination of the framed wall 6 in the opposite direction. Regardless of in which direction the framed wall 6 is inclined, appropriate corrective action may then be taken to assure that the framed wall 6 be properly vertically oriented.

Referring to FIGS. 2 and 4, mounting, movement, and locking of the optical beam projector 110 on the base 104 will be described. The base 104 may comprise a track disposed on the upper surface 106. As depicted, the track comprises two grooves 130, 132 which may extend into the base 104. Advantageously but not necessarily, the optical beam projector 110 may comprise one or more feet 134, 136 each comprising respective pins 138, 140 and enlarged heads 142, 144. The feet 134, 136 may engage the track by slidably traveling along their respective grooves 130, 132 along substantially almost all of the length of the base 104, as will be seen in FIG. 2. The optical beam projector may be retained within the grooves 130, 134 by interference fit therewith. The grooves 130, 134 may be partially closed at their open ends to entrap the enlarged heads 142, 144. One way of accomplishing this is to provide cover plates 146, 148, 150, 152, which may be dimensioned and configured to project into the grooves 130, 132 as seen in FIG. 4 to collectively define necks, or alternatively stated, channels which are just wide enough to enable the pins 138, 140 to pass therethrough but small enough to entrap the enlarged heads 142, 144. Regardless of how they are formed, the grooves 130, 132 engable the feet 134, 136 and their associated pins 138, 140 and enlarged heads 142, 144 to be dimensioned and configured to ride therein.

The legs 134, 136 may be anchored within standoffs 154, 156 as shown, or alternatively may be anchored within the body of the base 104 (this option is not shown).

The optical beam projector 110 may be locked at selected positions along the track to prevent inadvertent movement which would cause inaccuracies in measurement reading. This may be accomplished by providing a manual lock such as a clamp. For example, a clamp screw 158 may be threadedly carried in a tongue 160 projecting from the base 104 (the tongue 160 is best seen in FIG. 2). The tongue 160 may be an extension of a metallic plate 159 fixed to the top of the 110 for example. Alternatively, the clamp screw 158 may be replaced by a similar screw (not shown) which may be biased by spring action to engage the underside of those portions of the plates 148, 150 which project downwardly into a groove 162 formed in the base 104. Spring action may be imparted by spring characteristics of the tongue 160, which in turn may be determined by formation of a bend 161 at the juncture of the plate 159 and the tongue 160. The groove 162 need not extend nearly the full length of the base 104 as do the grooves 130, 132 due to the length of the optical beam projector 110. The clamp screw 158 may comprise an enlarged head 164 which abuts the lower surfaces of the plates 148, 150. Also, the clamping feature may be rearranged from the concept as presented herein to utilize either one or both of the grooves 130, 132, rather than using the groove 162 if desired.

The optical beam projector 110 may mount to the base 104 by rotatable quick connectors 166, 168 for example, to enable the optical beam projector 110 to be readily manually installed on and removed from the base 104.

Turning now to FIGS. 1 and 3, the handle 118 may comprise a pivot joint 170 which couples the handle 118 to the scale member 116 of the target component 114. Preferably but not necessarily, the handle 118 is adjustable in length, being formed in telescoping sections 172, 174. The section 174 may include a grip 175, for example, comprising a resilient sleeve which has texturing such as ribs 177 to facilitate grasp by the user. The section 172 may be pivotally fixed to the scale member by two wing screws 176, 178 which may thread through holes 180, 182 formed in respective trunnion brackets 184, 186 which are fixed to and projected outwardly from the lower surface 122 of the scale member 116. The threaded shafts of the wing screws 176, 178 pass into holes (not called out by reference numeral) formed in the section 172, thereby serving as an axle which supports and accommodates pivoting of the handle 118 relative to the scale member 116.

The telescoping sections 172, 174 may be adjustable in that they may be coupled to one another at selected ones of holes 188. The holes 188 will be understood to include holes formed in the inner section 174 and corresponding holes formed in the outer section 172, which may be aligned with one another to accept insertion of a spring loaded pin which, once passed through the aligned holes, lock the telescoping sections 172, 174 to one another. The spring loaded pin may be permanently mounted to and inside the inner section 174 so that in use, the user depresses the pin, urging the pin towards the interior of the inner section 174, thereby disengaging from the outer section 172. Spring action inherent in the mounting of the pin may automatically cause the pin to engage a newly selected hole formed in the outer section 172 when the holes formed in the inner and outer sections 172, 174 are aligned with one another, and the pin is not obstructed by the fingers of the user or by other objects. This type of releasable coupling of telescoping tubes is well known and need not be further described herein.

Although the invention has been described in terms of use in a vertical direction, the same principle of operation may be practiced in other orientations.

It would also be possible to reverse the functions of the optical beam projector component 102 and the target component 114 in that the optical beam projector 110 may be mounted to the scale member 116, with the base 104 bearing a measurement scale such as the measurement scale 124.

It would be possible to provide the optical beam projector component 102 with a handle such as the handle 118 if desired to facilitate maneuvering the optical beam projector component 102 along the floor surface 8.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An optical measurement tool for determining vertical registry of an upper point located along a vertically extending object with a lower point located along the vertically extending object, comprising:
an optical beam projector component comprising a base having an upper surface and a lower surface, a first linear measurement scale displaying measurement indicia disposed on the upper surface, and an optical beam projector movable along the base and disposed to project an optical beam vertically when the lower surface of the base is horizontally oriented; and
a target component comprising a scale member including an end surface, a lower surface bearing a second linear measurement scale displaying measurement indicia similar to that of the first linear measurement scale, and a handle coupled to the scale member.

2. The optical measurement tool of claim 1, wherein the base comprises a track disposed on the upper surface, and the optical beam projector comprises a foot disposed to engage the track such that the optical beam projector may slide along the track.

3. The optical measurement tool of claim 2, further comprising a manual lock disposed to releasably lock the optical beam projector at selected positions along the track.

4. The optical measurement tool of claim 2, wherein the track comprises a groove formed in the base, and the foot comprises a pin which is dimensioned and configured to ride in the groove.

5. The optical measurement tool of claim 4, wherein the groove includes a neck and an enlarged portion communicating with the neck, and extends along the length of the groove, and the pin comprises an enlarged head which is dimensioned and configured to be received in the groove in close cooperation therewith, and to be slidable along the groove.

6. The optical measurement tool of claim 2, wherein the manual lock comprises a clamp.

7. The optical measurement tool of claim 1, further comprising a pivot joint coupling the handle to the scale member of the target component.

8. The optical measurement tool of claim 1, wherein the handle is adjustable in length.

9. The optical measurement tool of claim 8, wherein the handle is formed in telescoping sections.

10. The optical measurement tool of claim 1, wherein the optical beam projector generates and projects collimated light.

11. The optical measurement tool of claim 1, wherein the optical beam projector generates and projects laser light.

12. The optical measurement tool of claim 1, wherein the optical beam projector is manually installable on and removable from the base of the optical beam projector.

13. The optical measurement tool of claim 12, further comprising a rotatable quick connector disposed to mount the optical beam projector to the base.

14. The optical measurement tool of claim 1, wherein the handle comprises a grip to facilitate grasp by the user.

15. The optical measurement tool of claim 1, wherein the 104 comprises at least one resilient pad to facilitate grasp by the user.

16. The optical measurement tool of claim 15, wherein there are two resilient pads located in opposition to one another on the base of the optical beam projector component.
